(19) United States
(12) Patent Application Publication
(10) Pub. No.: US 2013/0119160 A1
(43) Pub. Date: May 16, 2013

(54) PORTABLE SHOWER HEAD WITH AIR INLET COVER

(71) Applicant: Zhangjun Yu, Zhangzhou City (CN)

(72) Inventor: Zhangjun Yu, Zhangzhou City (CN)

(73) Assignee: SINYU TECHNOLOGY (FUJIAN) CO., LTD., Zhangzhou City, Fujian (CN)

(21) Appl. No.: 13/812,262

(22) PCT Filed: Sep. 13, 2010
(86) PCT No.: PCT/CN2010/076831

§ 371 Date: Jan. 25, 2013

(30) Foreign Application Priority Data
Jul. 29, 2010 (CN) 201020280521.4

(51) Int. Cl. B05B 1/00

(52) U.S. Cl. CPC B05B 1/00
USPC 239/532

(57) ABSTRACT

A portable shower head with an air inlet cover includes a decorative cover, a middle cover with soft rubber nozzles and a shower head body. Two air holes are provided on the middle cover. An air inlet connector with a hollow water channel is provided in the front part of the cavity of the shower head handle, and on the air inlet connector, air inlet holes are provided. A second inner wall is set in the front part of the cavity of the shower head handle. A front end sealing ring of the air inlet connector seals the second inner wall. A middle sealing ring of the air inlet connector seals a first inner wall of the shower head handle, so as to form the air space. A tail end sealing ring of the air inlet connector seals a water inlet pipe.

### BACKGROUND OF THE INVENTION

1. Field of the Invention

The present invention relates to an air inlet portable shower head, and more particularly to a portable shower head with an air inlet cover.

2. Description of the Prior Art

A conventional air inlet portable shower head has air inlet holes disposed at the handle of the shower head. When switching off the water, the remaining water will flow out from the air inlet holes of the handle of the shower head. The user may feel uncomfortable when the shower head is leaking water. Accordingly, the inventor of the present invention has devoted himself based on his many years of practical experiences to solve these problems.

### SUMMARY OF THE INVENTION

The primary object of the present invention is to provide a portable shower head is with an air inlet cover, preventing the shower head from leaking after switching off.

In order to achieve the aforesaid object, the portable shower head with an air inlet cover of the present invention comprises a decorative cover, a middle cover with soft rubber nozzles, and a shower head body. The decorative cover and the middle cover are connected by welding to form an air chamber therebetween. The middle cover has two air holes thereon. The two air holes communicate with the shower head body and an air space in a front part of a cavity of a shower head handle of the shower head body. An air inlet connector with a hollow water channel is provided in the front part of the cavity of the shower head handle. The air inlet connector has an air inlet hole thereon to communicate with the hollow water channel. The air inlet hole is located in the air space. The front part of the cavity of the shower head handle has a second inner wall. The air inlet connector is provided with a front end sealing ring to seal the second inner wall. The air inlet connector is provided with a middle sealing ring to seal a first inner wall of the shower head handle so as to form the air space. The air inlet connector is provided with a tail end sealing ring to seal a water inlet pipe so as to seal water.

The effect of the present invention is that air enters the air chamber formed between the decorative cover and the middle cover through the gap between the decorative cover and the soft rubber nozzles, and flows to the air space at the front part of the cavity of the shower head handle of the shower head body through the two air holes of the middle cover, and then enters the hollow water channel through the air inlet hole to mix with water to form aerobic water. Thus, the remaining water formed by reflux after switching off is remained in the air chamber, and the remaining water will enter the water channel with the air while switching on the next time.

### BRIEF DESCRIPTION OF THE DRAWINGS

FIG. 1 is an exploded view of the present invention;

FIG. 2 is a perspective view showing the air inlet connector of the present invention;

FIG. 3 is a partial sectional view of the present invention;

FIG. 4 is a schematic view showing the middle cover with soft rubber nozzles of the present invention; and is FIG. 5 is another partial sectional view of the present invention.

### DETAILED DESCRIPTION OF THE PREFERRED EMBODIMENTS

Embodiments of the present invention will now be described, by way of example only, with reference to the accompanying drawings.

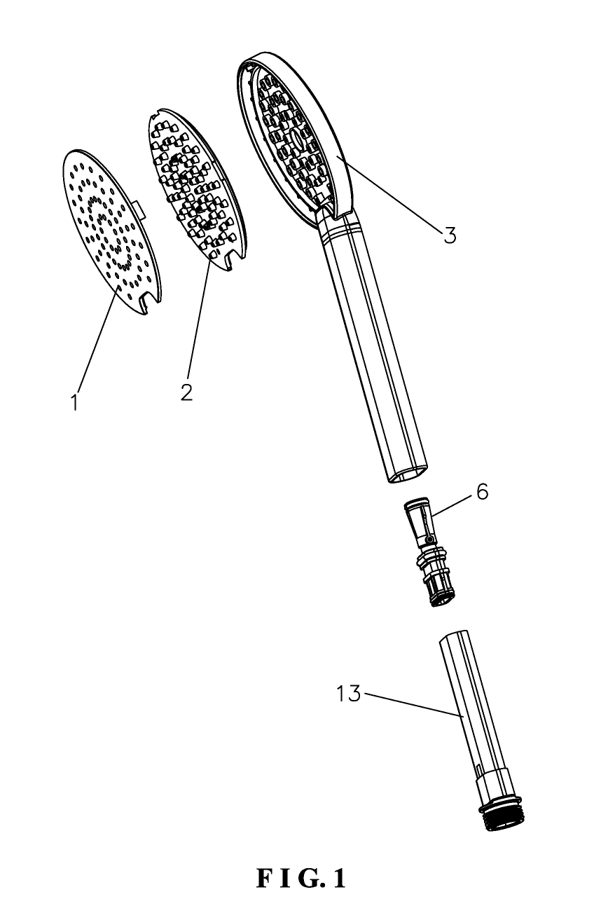

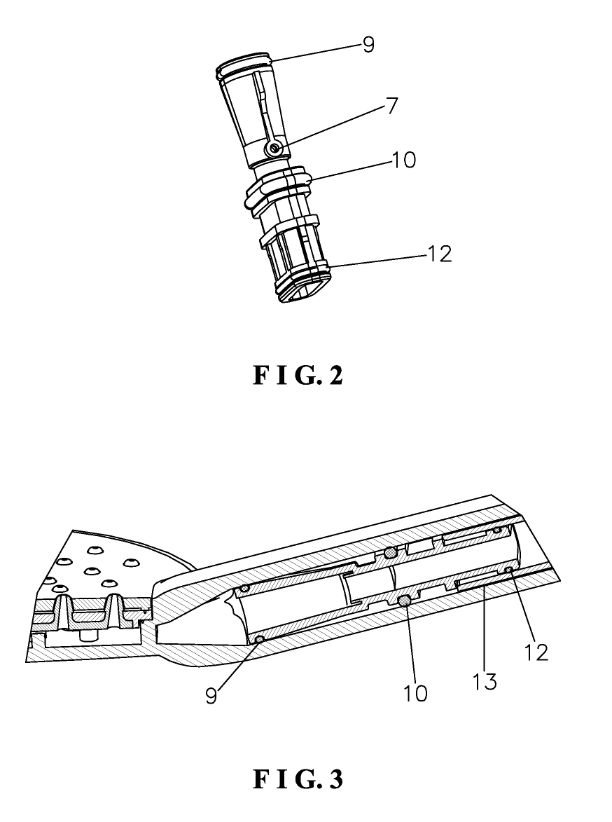

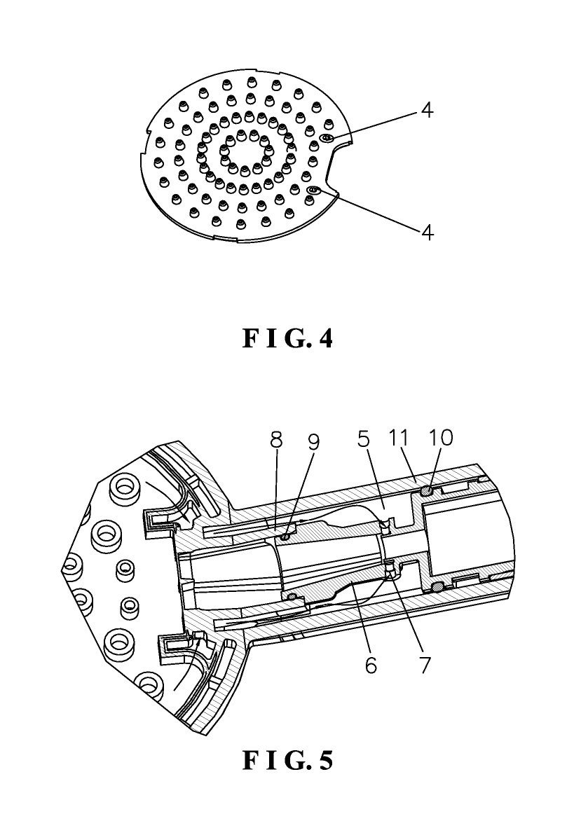

As shown in FIG. 1 to FIG. 5, the portable shower head with an air inlet cover of the present invention comprises a decorative cover 1, a middle cover 2 with soft rubber nozzles, and a shower head body 3.

The decorative cover 1 and the middle cover 2 are connected by welding to form an air chamber therebetween.

The middle cover 2 has two air holes 4 thereon. The two air holes 4 communicate with the shower head body 3 and an air space 5 in a front part of a cavity of a shower head handle of the shower head body 3.

An air inlet connector 6 with a hollow water channel is provided in the front part of the cavity of the shower head handle. The air inlet connector 6 has an air inlet hole 7 thereon to communicate with the hollow water channel. The air inlet hole 7 is located in the air space 5. The shower head handle has a first inner wall 11, and the front part of the cavity of the shower head handle has a second inner wall 8.

As shown in FIG. 3 and FIG. 5, to assemble the present invention, the air inlet connector 6 is first inserted into a water inlet pipe 13, and then the water inlet pipe 13 is inserted into the shower head handle. The air inlet connector 6 is provided with a front end sealing ring 9 to seal the second inner wall 8. The air inlet connector 6 is provided with a middle sealing ring 10 to seal the first inner wall 11 of the shower head handle so as to form the air space 5. The air inlet connector 6 is provided with a tail end sealing ring 12 to seal the water inlet pipe 13 so as to seal water. As shown in FIG. 5, the arrow shows the air inlet direction.

As shown in FIG. 5, the arrow shows the air flow direction when in use. The air enters the air chamber formed between the decorative cover 1 and the middle cover 2 through the gap between the decorative cover 1 and the soft rubber nozzles, and flows to the air space 5 at the front part of the cavity of the shower head handle of the shower head body 3 through the two air holes 4 of the middle cover 2, and then enters the hollow water channel through the air inlet hole 7 to mix with water to form aerobic water. Thus, the remaining water formed by reflux after switching off is remained in the air chamber, and the remaining water will enter the water channel with the air while switching on the next time.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A portable shower head with an air inlet cover, comprising a decorative cover, a middle cover with soft rubber nozzles and a shower head body, the decorative cover and the middle cover being connected by welding to form an air chamber therebetween; the middle cover having two air holes thereon, the two air holes communicating with the shower head body and an air space in a front part of a cavity of a shower head handle of the shower head body; an air inlet connector with a hollow water channel being provided in the front part of the cavity of the shower head handle, the air inlet connector having an air inlet hole thereon to communicate with the hollow water channel, the air inlet hole being located in the air space, the front part of the cavity of the shower head handle having a second inner wall, the air inlet connector being provided with a front end sealing ring to seal the second inner wall, the air inlet connector being provided with a middle sealing ring to seal a first inner wall of the shower head handle so as to form the air space, the air inlet connector is being provided with a tail end sealing ring to seal a water inlet pipe so as to seal water.

2. The portable shower head with an air inlet cover as claimed in claim 1, wherein the middle cover has two air holes thereon.
